(19) United States
(12) Patent Application Publication
(10) Pub. No.: US 2009/0123260 A1
(43) Pub. Date: May 14, 2009

(54) Tilting bed trailer

(76) Inventor: Michael Howard-Leicester, Atascadero, CA (US)

Correspondence Address: Donald W. Meeker;Patent Agent, 924 East Ocean Front #E, Newport Beach, CA, 92661, US

(21) Appl. No.: 11/983,504

(22) Filed: Nov. 9, 2007

(51) Int. Cl. B60P 1/28; B60P 1/30; B62D 59/02

(52) U.S. Cl. 414/475; 280/423.1; 414/477; 414/483

(57) ABSTRACT

A cradle has wheels and suspension system and channels or raceways and blocks or a brake for maintaining the cradle in a stationary position relative to the ground during loading and unloading. A load bed with top loading ramps and a bottom pair of wedge slide ramps rides on the raceways pushed and pulled by a tow arm from a towing vehicle. The wedge slide ramps provide a vertical cam action gradually elevating a forward end of the load bed as the wedges move onto the raceways for tilting the load bed so that the back end of the loading ramps tilt down to contact the ground for loading.

### CROSS-REFERENCE TO RELATED APPLICATIONS

Not Applicable.

### STATEMENT REGARDING FEDERALLY SPONSORED RESEARCH OR DEVELOPMENT

Not Applicable.

### THE NAMES OF THE PARTIES TO A JOINT RESEARCH OR DEVELOPMENT

Not Applicable.

### BACKGROUND OF THE INVENTION

1. Field of the Invention

The present invention relates to trailers that have decks which can be tilted for loading and can be righted to a horizontal position for transportation, and particularly to a trailer that comprises a cradle with channels or raceways for receiving a sliding bed or deck, and to which are attached a wedge ramp for tilting the sliding deck and providing a camming action, one or more axles, a suspension system, a braking system, wheels, tires and a tow arm.

2. Description of Related Art Including Information Disclosed Under 37 CFR 1.97 and 1.98

Trailers or haulers are well known in both flatbed and tilting type for the transportation of loads, equipment and automobiles. These trailers designed to be towed behind or on a motorized vehicle, such as a truck or a car.

Trailers are generally one axle (two wheels) or two axles (four wheels) and can be up to three or more axle multi-wheel, which results in an increase in length and payload carrying ability. Trailers can be of the sprung or unsprung design using a leaf spring, coil spring, torsion bar or rubber in sheer type suspension to cushion the load. Further the trailer, be it single or multi-axle design, can incorporate a braking system using drum or disc brakes on one or more axles. These trailers generally have built-in or attached loading ramps at the rear of the bed to facilitate the loading and unloading of the item being transported.

In the case of the tilting bed trailer, the bed or deck is pushed up at its front end of the bed by electric, hydraulic ram, screw, pulleys or gears, allowing the back end of the bed to fall as the front end rises allowing the back of the bed to fall as the front rises around a pivot point acting as a fulcrum and thereby allowing the load to be placed, pushed, conveyed, winched or driven onto the trailer bed. This can further be assisted by the use of ramps or extendible platform(s) off the rear of the trailer bed. All of the above are well known and prove to be cumbersome, time consuming and unreliable. The prior art fails to provide a simple inexpensive and east-to-use solution to the tilt-bed trailer.

U.S. Patent Application #20070003398, published Jan. 4, 2007 by Hernandez, puts forth a trailer having a base frame and an upper frame, the base frame adapted to be removably secured to a vehicle, while the upper frame having a rear end and a forward end is pivotally connected along its intermediate length to the base frame. The upper frame incorporates a pair of spaced axles having dual wheels on both ends of the axles, as well as a winch assembly. The upper frame also incorporates slidably moving means to move a container relative thereto. A hydraulic cylinder is operably and pivotally mounted between the upper frame and base frame to enable the upper frame to be moved between a first position and a second position relative to the base frame. The upper frame is pivotally connected to the base frame such that the upper frame can tilt from a first position, the length of which is substantially parallel to the length of the base frame, to a second position where the upper frame is tilted. In the second position, a container that is located at ground level can be easily loaded onto the upper frame. A forward portion of the container engages the rear end of the upper frame and is displaced along the length of the upper frame using slidably moving means and the winch assembly.

U.S. Patent Application #20070065263, published Mar. 22, 2007 by Trudeau, concerns a trailer operable in lowered and raised transport positions. The trailer includes a deck frame which can be supported in a lowered transport position in which the deck frame is spaced above the ground below a height of the wheels corresponding to a deck between configuration and a raised transport position in which the deck frame is spaced above the ground substantially at or above the height of the wheels corresponding to a deck over configuration. Consumers are thus only required to purchase a single trailer to meet the advantages of both trailer configurations. Load supports, independent of a lift mechanism of the trailer, are provided in addition to the linkage which controls displacement of the deck frame between the two positions to ensure that the deck frame is supported on the wheels in a manner so as to safely bear a load on the deck frame in both the lowered and raised positions.

U.S. Patent Application #20050161978, published Jul. 28, 2005 by Barton, illustrates a split-tilting trailer for off-road vehicles that can be loaded and unloaded easily by one person without the need for ramps. The trailer has side-by-side beds that independently tilt while the trailer is hitched to the tow vehicle, and which are locked in the horizontal position for transportation. The beds are balanced so that they gently tilt back when they are not locked. A coverall can be provided to protect the vehicles during transportation.

U.S. Patent Application #20040105743, published Jun. 3, 2004 by Franklund, shows a tilting flatbed trailer system for facilitating safe and efficient loading/unloading of cargo. The tilting flatbed trailer system includes a main frame, a plurality of end rollers rotatably attached to the main frame, a hydraulic cylinder attached to the main frame, a bed frame slidably positioned upon the main frame and connected to the hydraulic cylinders, and a plurality of support arms pivotally attached to the main frame and slidably connected to the bed frame. When the hydraulic cylinder is extended, the front of the bed frame is elevated and the bed frame simultaneously slides rearwardly thereby providing a low incline for loading/unloading cargo.

U.S. Patent Application #20040052623, published Mar. 18, 2004 by Legum, describes a trailer having an upper surface for loading, unloading and transporting vehicles, and operable to reposition the upper surface to provide an angled ramp or jump for use with vehicles such as motorcycles and other recreational vehicles.

U.S. Patent #20020081182, published Jun. 27, 2002 by Harris, puts forth an improved trailer that comprises a drawbar, a deck connected to the drawbar by a pivot connection, an axle carriage and an actuator. The axle carriage includes at least two skids and the deck is provided with skid runners for supporting the deck on the axle carriage skids. The actuator is operably connected to cause movement of the axle carriage, relative to the deck, between a first, road position and a second, load position in which the deck is pivoted to a low rise, loading position. The deck may comprise a main deck and a loading deck with the main deck connected to the drawbar by a pivot connection near the front of the trailer. The main deck and the loading deck include skid runners for supporting the deck on the axle carriage skids. The main deck is connected to the loading deck by a pivot connection adjacent the rear of the trailer. An actuator is operably connected to cause movement of the axle carriage, relative to the deck, between a first, road position and a second, load position in which a rear portion of the trailer rests on the ground. A second actuator is operably connected to cause relative movement between the main deck and the loading deck between a first, road position, where their upper surfaces are substantially co-planar, and a second, loading position where a forward portion of the loading deck is resting on the ground. A rear gate is connected by a pivot connection to the rear of the main deck and the loading deck, and a third actuator is operably connected to cause relative movement between the gate and the deck between a first, up, road position, a second position where a lower surface of the gate rests on the ground, and a third position in which an upper surface of the deck is substantially co-planar with upper surfaces of the deck.

U.S. Pat. No. 5,564,883, issued Oct. 15, 1996 to Swanner, provides a lever-operated pivoting-bed trailer. The forward portion of a cargo trailer bed is pivotally supported within a U-shaped frame. The rearward portion of the bed is supported by a lift bar pivotally attached to a rear of the frame, the lift bar acting as a lever to lower the rear end of the bed to ground level and to raise the bed to a loaded position for towing.

U.S. Pat. No. 5,137,414, issued Aug. 11, 1992 to Sloan, shows an improved translatable tilt-bed trailer that has an elongated support bed which is rollingly mounted on the top side of a dual axle, wheeled undercarriage provided with a manually operable mechanical brake system and a front-to-rear spring equalizing system. The front end of the support bed is provided with a lockable, articulated tongue portion connectable to the hitch ball of a towing vehicle. To load an item onto the support bed, the mechanical trailer brakes are locked; the articulated tongue, and a pair of support bed retaining pins, are unlocked; and the towing vehicle is backed toward the stationary undercarriage to rearwardly move and downwardly tilt the bed. As the rear end of the tilting bed touches the ground, a pair of front stops on the bed engage the undercarriage frame and stop the rearward movement of the bed. The item to be loaded is then moved up the inclined bed and suitably secured thereto. The towing vehicle is then moved forwardly to roll the bed back to its original position on the undercarriage and tilt it back to a horizontal orientation, at which time rear stops on the bed interlock with the undercarriage frame and the bed retaining pins automatically snap back to their bed-locking positions. The articulated tongue is then re-locked, and the trailer brakes released, to permit the loaded item to be towed away.

U.S. Pat. No. 5,775,868, issued Jun. 7, 1998 to Mann, claims a movable-deck trailer that includes a frame with front and back ends, a tongue assembly mounted on the frame front end and a deck mounted on top of the frame. A wheeled carriage is mounted on the frame between its front and back ends and includes a pair of walking beam assemblies adapted for pivoting with respect to the frame. Each walking beam assembly mounts multiple torque tube axle/suspension assemblies. The carriage is longitudinally movable with respect to the frame and deck. A multiple-vehicle, movable-deck trailer includes multiple deck portions, the rearmost being tiltable. A movable-deck trailer adapted for tilting under the influence of either gravity or hydraulic power includes a hydraulic piston-and-cylinder unit interconnecting a frame and a tongue assembly thereof. A movable-deck trailer with a deck adapted for raising to the height of a loading dock includes hydraulic cylinders for raising and lowering same with respect to a frame.

U.S. Pat. No. 6,036,207, issued Mar. 14, 2000 to Oehlerking, describes a trailer that includes a longitudinally extending frame comprised of longitudinally extending frame members, which have rearward and forward ends. Each of the frame members has a first section modulus which is positioned forwardly of the rearward end thereof, at least a second section modulus which is positioned forwardly of the first section modulus, and a transition section modulus positioned therebetween. A running gear is longitudinally slidably mounted on the frame members and has running gear retainers mounted thereon which slidably embrace the lower end of the frame members. When the running gear is in its transport position, a spacer is provided between the running gear retainers and the frame members to prevent excessive play therebetween. The retainers are designed so that once the retainers move out of engagement with the spacers, there is sufficient play or gap between the retainers and the frame members to enable the running gear to move from the first section modulus to the second section modulus. The varying of the section modulus on the frame members enables the trailer to accommodate heavy loads without increasing the deck height or affecting the tilt angle thereof.

U.S. Pat. No. 5,051,053, issued Sep. 24, 1991 to Groeneweg, discloses a tilting bed trailer apparatus that has a perimeter frame with a front, rear and intermediate portion thereof. The trailer includes a trailer hitch attached to the front of the perimeter frame for permitting it to be attached to a towing vehicle. Wheels are rotatably attached to the perimeter frame and have axle-supporting structures passing between the left and right side aligned wheels. The tilting bed is pivotally attached at a point above and midway between the rotational axes of the axles, in the case of a tandem wheel arrangement having two wheels on each side thereof, or immediately above the axle on a trailer having just one wheel on each side thereof. By having the tilting bed pivotally connected to a perimeter frame at this point, the perimeter frame of the trailer will not have a tendency to tip during the loading process.

U.S. Pat. No. 6,045,316, issued Apr. 4, 2000 to Dole, puts forth a fifth wheel rollback trailer that consists of three basic parts, a fifth wheel pull frame, a tilt frame, and a slide frame. The tilt frame is mounted on the pull frame above the axle and is tilted by a hydraulic cylinder. The slide frame is moved by a hydraulic cylinder, which is fastened to the tilt frame.

U.S. Pat. No. 4,702,662, issued Oct. 27, 1987 to Marlett, concerns a utility trailer especially suited for transporting an automobile, which has a vehicle carriage that is reciprocally moveable to longitudinally and tiltable relative to the trailer frame to provide a shallow ramp for loading and unloading the vehicle. The trailer includes a self contained gasoline powered engine for driving a hydraulic fluid actuated system for controlling the position of the moveable carriage and a winch. The trailer includes a stop bar to prevent movement of the trailer during loading and unloading. The carriage is a rigid flat platform connected to an auxiliary frame that is pivotally connected to the main trailer frame. The carriage can be moved parallel to the auxiliary frame by the hydraulic actuator.

U.S. Pat. No. 4,125,198, issued Nov. 14, 1978 to Landoll, illustrates a trailer that has a tiltable bed and a wheel-supported undercarriage. The trailer has a structure mounting the undercarriage for reciprocal movement fore and aft of the bed between a forward, bed-tilting position and a rearmost, loading position wherein the bed is carried lower to the ground to accommodate higher loads. The mounting structure includes a pair of tracks on the bed and a series of ramps for raising the bed relative to the undercarriage when the latter is shifted from its loading position such that sufficient spacing between the bed and the undercarriage is provided for clearance of the bed understructure during movement of the undercarriage along its fore and aft path of travel.

U.S. Pat. No. 4,813,841, issued Mar. 21, 1989 to Eischen, is for a vehicle carrier that features a tiltable vehicle bed which, when a vehicle is driven rearwardly on the bed, both tilts upwardly at its front end and slides rearwardly to the ground so that the vehicle can be unloaded, the bed thereby making a less abrupt angle with the ground for facilitating unloading and loading of the vehicle. When a vehicle is driven onto the tilted bed, the latter both tilts downwardly at its front end and slides forwardly. All the foregoing is accomplished automatically by the vehicle itself without the need of any additional form of power to tilt or slide the bed.

U.S. Pat. No. 4,943,202, issued Jul. 24, 1990 to Galloway, provides a tilting mobile platform that comprises a platform that has an upper surface and a lower surface with a first and a second rail member securely fastened to the lower surface of the platform. An axle supporting frame is slidably secured to the rail members. A first axle is rotatably attached to the axle supporting frame such that the axle is transversely mounted on the axle supporting frame relative to a path of movement of the axle supporting frame along the rail members. An axle supporting frame moving means moves the axle supporting frame along the first and the second rail members from a first position to a second position. The axle further includes a first and a second axle arm extending perpendicular to the axle and each axle arm further includes a stud extending substantially perpendicular relative to the axle arm and parallel to the axle. A first and a second ground engaging wheel is rotatably attached to each parallel stud for movably supporting the platform and the articles placed thereon. The platform includes a means to enable the platform to be moved along the ground. An axle rotating means rotates the axle such that in use when the axle is rotated the axle arms rotate from a first angle to a second angle and when the axle supporting frame is positioned at the second position, the platform defines a ramp position and when the axle is further rotated the axle arms form the first angle and when the axle supporting frame is positioned at the second position, the platform defines a hauling position.

U.S. Pat. No. 3,624,786, issued Nov. 30, 1971 to Lundahl, shows a tilt bed vehicle that is supported by a chassis and a separate wheeled undercarriage, all interconnected so that the undercarriage is moved forwardly in relation to the bed as the latter is tilted. The undercarriage includes a pair of wheeled trucks, which swing about horizontal and vertical axes. Each truck includes a front, a rear and an intermediate wheel and axle assembly. The intermediate assembly is pivotally mounted for swinging movement about an axis that extends fore and aft of the vehicle.

U.S. Pat. No. 3,690,490, issued Sep. 12, 1972 to Hall, claims a trailer construction in which a load supporting platform is shiftable rearwardly with respect to a supporting axle while its rearmost edge is pivoted downwardly to provide a resultant small angle of inclination between the platform frame and the ground surface.

U.S. Pat. No. 5,775,711, issued Jul. 7, 1998 to Floe, is for a tilt-bed trailer constructed of light weight and durable materials. A trailer frame with an associated rotatably interconnected tongue is affixed with a tongue release and retention mechanism that slidably engages a portion of the tongue and a portion of the frame to hold them in a fixed position when engaged and to allow the frame to pivot with respect to the tongue when disengaged. The mechanism utilizes gripping members to cooperate with ridges on the tongue. An adjustable axle mount has a pair of parallel support members having a predetermined configured channel in the lower surface of each, that slidably engage mating axle mount members therein. A locking mechanism allows positioning of the axle mount members selectably along the length of the channels.

U.S. Pat. No. 6,527,494, issued Mar. 4, 2003 to Hurlburt, provides a trailer frame configuration which is operable in both a tilt mode of operation and a dump mode of operation. An actuating mechanism includes a linear actuator that is supported on the frame by a bracket and a yoke that connects to a load bed to power the vertical movement of the load bed in both tilt and dump functions. The linear actuator is pivotally mounted to permit a re-positioning of the actuator into an inoperative position. The frame configuration is provided with an articulated tilt frame in which the tongue is pivoted thereto allowing the load bed to pivot about a tilt axis which can coincide with the wheel axis of the trailer. The bed frame can be locked to the tilt frame for tilting upon articulation with the tongue, while a disconnection of the bed frame from the tilt frame enables the bed frame to pivot about the dump axis to provide a dump function in addition to the tilt function. The actuator can pivot about the connection thereof to the bed frame to position the actuator into a lowered inoperative transport position generally parallel to the trailer tongue. A modified screw jack can be part of a kit that can be utilized to provide the powered operations of the tilt function for existing gravity-based tilt trailers.

Two U.S. Pat. Nos. 4,168,932 issued Sep. 25, 1979 and 4,109,809 issued Aug. 29, 1978 to Clark, show a multiple position vehicle carrying trailer adapted to carrying a plurality of vehicles, such as snowmobiles, includes a plurality of wheels and a pair of vehicle supporting trailer beds normally disposed in a use position in side-by-side relationship on a frame. Each one of the trailer beds is pivotally mounted on the frame at the rear edge thereof forwardly of the mid-point of the bed to enable it to tilt individually and independently backwardly until its rear edge contacts the ground for loading and unloading purposes and to enable the loaded bed to tilt back to its horizontal use position under the weight of the vehicle supported by it. Bumper devices are disposed on the frame for cushioning the movement of the bed under the weight of the vehicle, and latching devices hold the beds releasably in their horizontal position. Camming devices engage the beds as they move into their use positions for moving the latches to their release position, and spring biasing devices enable the latching devices to return to their holding positions. An elongated locking device prevent the locking devices from moving out of engagement with the bed. Pin devices secure releasably the latching devices in engagement with the beds. A locking rod extends through aligned apertures in the bed to secure releasably said bed to one another. Elongated leaf springs extend in a direction parallel to the axis of rotation of the wheels for cushioning the beds.

U.S. Pat. No. 7,134,829, issued Nov. 14, 2006 to Quenzi, claims a trailer for carrying cargo including a frame, at least two axles mounted to the frame, and a deck. The axles have wheels at opposite ends of the axles for movably supporting the frame above the ground. The deck is pivotally mounted to the frame and is pivotable about a first axis relative to the frame and a second axis relative to the frame via at least two supports. The first axis extends generally longitudinally along the deck and the second axis extends generally laterally across the deck and generally normal to the first axis. The deck is also slidable generally along the first axis relative to the frame and/or one of the supports. The deck thus may be adjusted about multiple axes and may be moved forwardly or rearwardly relative to the frame to position the deck in a desired location and orientation relative to the frame.

What is needed is a unique structure and arrangement to facilitate a more advanced and simplified method of tilting a trailer bed at various and lesser angles and rates of fall in an easier method of allowing loading and unloading of loads, equipment, containers and/or vehicles by using a ‘cradle’ to which are attached one or more axles, suspension system, brakes system, tires and wheels.

### BRIEF SUMMARY OF THE INVENTION

An object of the present invention is to provide a ‘cradle’ to which are attached one or more axles, suspension system, brakes system, tires and wheels to create a unique structure and arrangement to facilitate a more advanced and simplified method of tilting a trailer bed at various and lesser angles and rates of fall in an easier method of allowing loading and unloading of loads, equipment, containers and/or vehicles.

Another object of the present invention is to provide a tilting/pivoting loading bed which moves slowly and smoothly due to camming action of wedge slide ramps.

One more object of the present invention is to provide loading ramps for wheeled vehicles to drive up.

An additional object of the present invention is to provide a winch to allow for pull cable loading of items.

In brief, the tilt-bed trailer of the present invention has a cradle with wheels and suspension system and channels or raceways for receiving a load bed with top loading ramps and a bottom pair of wedge slide ramps or cams for riding on the raceways providing a camming action gradually elevating a forward end of the load bed as the wedges move onto the raceways for tilting the load bed so that the back end of the loading ramps tilt down to contact the ground for loading, and a tow arm attached to a towing vehicle at a forward end and attached to the central area of the load bed by a pivot pin so that as the vehicle backs up with the wheels of the cradle locked in place and the load bed unlocked from the cradle and unlocked from the forward end of the towing bar, the towing bar pushes the load bed back over the cradle.

An advantage of the present invention is that the loading bed tilts down to form a ramp for easy loading of operational wheeled vehicles.

Another advantage of the present invention is that a winch may be provided for pull cable loading of other items.

One more advantage of the present invention is that the towing vehicle provides the force which moves the bed in a controlled steady movement to tilt down for loading/unloading and back in a controlled steady movement into locked and “ready to tow” position so that the loading bed doesn't drop quickly.

An additional advantage of the present invention is the bed is pivoted into loading position smoothly, slowly and evenly because of a vertical camming system.

A further advantage of the present invention is it provides an easier method of allowing loading and unloading of loads, equipment, containers and/or vehicles.

An additional advantage is that the system needs less force or energy to push/pull the load/vehicle to be loaded up the bed to its loaded position.

### BRIEF DESCRIPTION OF THE SEVERAL VIEWS OF THE DRAWINGS

These and other details of my invention will be described in connection with the accompanying drawings, which are furnished only by way of illustration and not in limitation of the invention, and in which drawings:

FIG. 1 is a side elevational series of views A-E showing the tilt-bed trailer of the present invention as the loading bed is tilted from the traveling position in A to the loading position in E:

FIG. 2 is a side elevational view of a vehicle being loaded onto the loading ramps of the tilt-bed trailer of FIG. 1;

FIG. 3 is a perspective view of the load bed and towing arm of the tilt-bed trailer of FIG. 1;

FIG. 4 is a perspective view of the cradle of the tilt-bed trailer of FIG. 1 showing the raceways and tires and suspension system;

FIG. 5 is a perspective view of the entire tilt-bed trailer of FIG. 1 shown in the travel position with the load bed down on the cradle;

FIG. 6 is a partial side elevational view showing the back ends of the cradle and load bed showing a metal ‘L’ shaped bracket connected the underside of the load bed that engages the rear most part of the cradle;

FIG. 7, is a partial side elevational view showing the back ends of the cradle and load bed showing a locator pin connected to the underside of the load bed that engages the rear most part of the cradle.

### DETAILED DESCRIPTION OF THE INVENTION

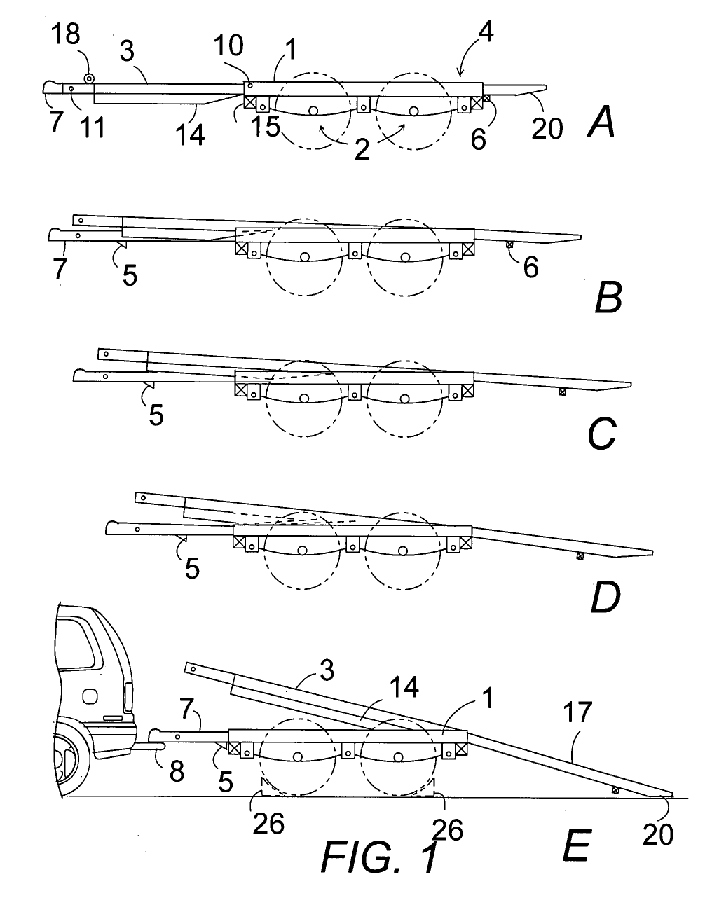

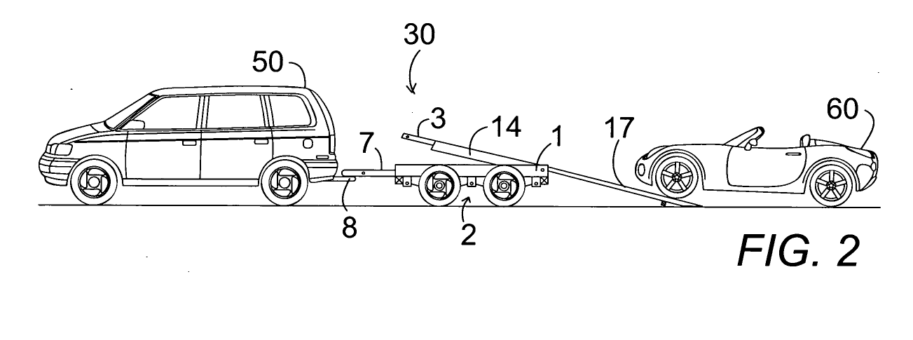

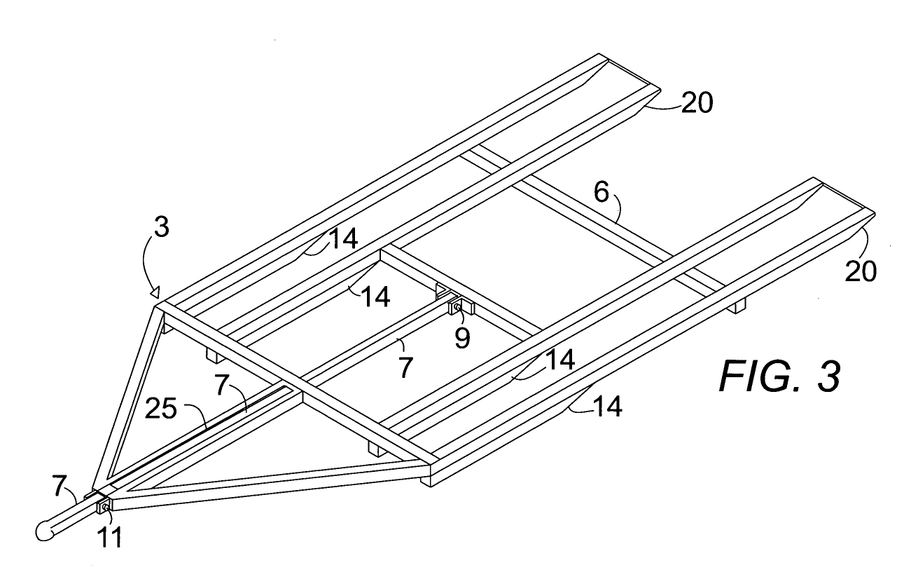

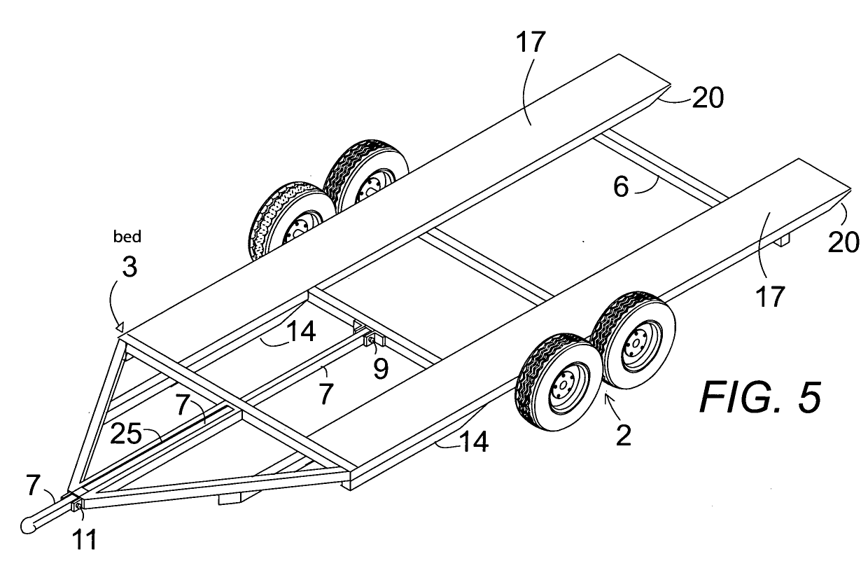

In FIGS. 1-5, a tilt-bed trailer comprises a cradle 1 with a parallel pair of raceways 4 and wheels and suspension system 2, shown in FIG. 3, a load bed 3 with a top parallel pair of loading ramps 17 which ride over the raceways 4 and a pair of slide ramp cams or wedges 14 under the loading ramps which ride on the raceways, shown in FIG. 3, a towing arm 7 attached to a vehicle hitch 8 at a forward end. It is attached to the central area of the load bed 3 by a pin 9 allowing the load bed 3 with the loading ramps 17 to tilt vertically up from the towing arm at a forward end and tilt down to the ground for loading and unloading at a rearward end of the load bed.

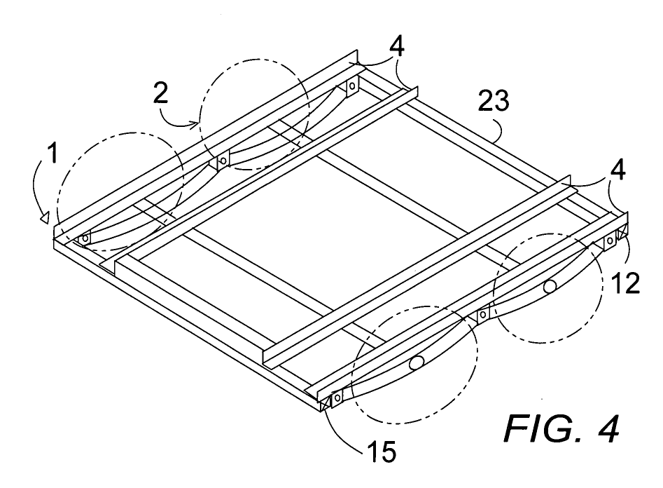

in FIG. 4, the cradle 1 comprises an elongated support structure mounted on a suspension system and axles and wheels 2, at least one pair of raceways 4 mounted in a parallel spaced array along the length of the cradle, and a means, such as wheel brakes or blocks, for maintaining the cradle in a stationary position relative to the ground surface below on which the wheels are resting.

In FIG. 3, the load bed 3 is slidably mounted to slide forward and backward in the raceway(s). The load bed comprises a pair of loading ramps 17 along the length of the load bed extending beyond a back portion of the load bed. The pair of loading ramps is aligned with the at least one pair of raceways 4 on the cradle, and at least one pair of front and back bed stops, a towing arm stop 5 and a load bed stop 6, respectively, interacting with the cradle stops, 15 and 12, to limit forward and backward movement of the load bed. The load bed 3 floats back and forth on at least one pair of raceways 4 on the cradle 1 between the cradle stops 15 and 12. There is also a means for locking 10 the load bed 3 to the cradle 1 to prevent relative motion there between when transporting a load, and a central channel 25 opening downwardly in a forward portion of the load bed to allow the load bed 3 to pivot up away from the towing arm 7.

In FIG. 3, the towing arm 7 fits within the center channel 25 of the load bed to locate the arm 7 and prevent lateral movement of the arm in relation to the bed 3 and cradle 1 during towing. The towing arm 7 is an elongated rigid arm having an attachment to a tow vehicle hitch 8, as shown in FIG. 1E, at a proximal end of the towing arm and a pivoting attachment 9 to a center portion of the load bed at a distal end of the towing arm, and at the load bed center line. There is also a means for locking the towing arm 7 onto the load bed 3 using the towing arm locking pin 11 with the towing arm in a forward position in the load bed central channel for towing.

There are at least two wedges or slide ramp cams 14 attached to an underside of the load bed 3 along the sides of the load bed, so that the slide ramp cams 14 ride in the channels 4 of the cradle. Each of the slide ramp cams 14 comprises an elongated rigid wedge tapering downwardly from a forward pointed end to a lower planar surface spaced apart from the bottom of the load bed 3. With the cradle 1 held stationary relative to the ground and the load bed 3 unlocked from the cradle and unlocked at the proximal end from the towing bar 7 by removing towing bar locking pin 11, the towing vehicle when backing up will push the towing arm 7 and loading bed 3 backward over the cradle. This causes the slide ramp cams 14 to act in unison, sliding in the raceways 4 as vertical motion cams to elevate the front of the loading bed 3 relative to the cradle 1 and cause a back end of the load bed or loading ramp 17 to extend rearward of the cradle and tilt downward from the pivoting attachment 9 on the distal end of the towing arm. The loading ramp 17 then comes in contact with the ground with the tapered ends 20 of the leading ramps flat on the ground, as in FIG. 1E, to move a load on the pair of loading ramps. When the load movement is complete, and the towing vehicle 50 moves forward to pull the towing arm 7 and the load bed 3 forward and the slide ramp cams 14 slide forward over the cradle 1 in the raceways 4 to act as vertical motion cams to lower the load bed 3 back onto the cradle 1.

In FIG. 4, the cradle 1 further comprises a front cradle stop 15 at a front end of the cradle and a back cradle stop 12 at a back end of the cradle. The towing arm 7 has a towing arm stop 5 on an underside of the towing arm adjacent to the proximal end of the towing arm. This allows the towing arm stop 5 to interact with the front cradle stop 15 to stop backward movement of the towing arm 7 and the attached load bed 3. The load bed 3 also has a load bed stop 6 on an underside of the load bed adjacent to a distal end of the load bed. This allows the load bed stop 6 to interact with the back cradle stop 12 to stop a forward movement of the load bed.

In FIG. 1A, a manually installed cradle locking pin 10 is used to lock the load bed 3 to the cradle 1. This could also be comprised of an electrically controlled solenoid, or spring loaded pin.

The means for maintaining the cradle in a stationary position may comprise a pair of blocks 26, as in FIG. 1E, wedged under a front and back of one of the wheels or a set brake in the wheels.

In FIG. 1A, the present invention may further comprise a winch 18 attached to a topside of the load bed 3 adjacent to the proximal end of the load bed to assist loading and unloading. The winch 18 comprises at least one variety of winches taken from the list of varieties of winch including an electrically operated winch, a hydraulically operated winch and a manually operated winch.

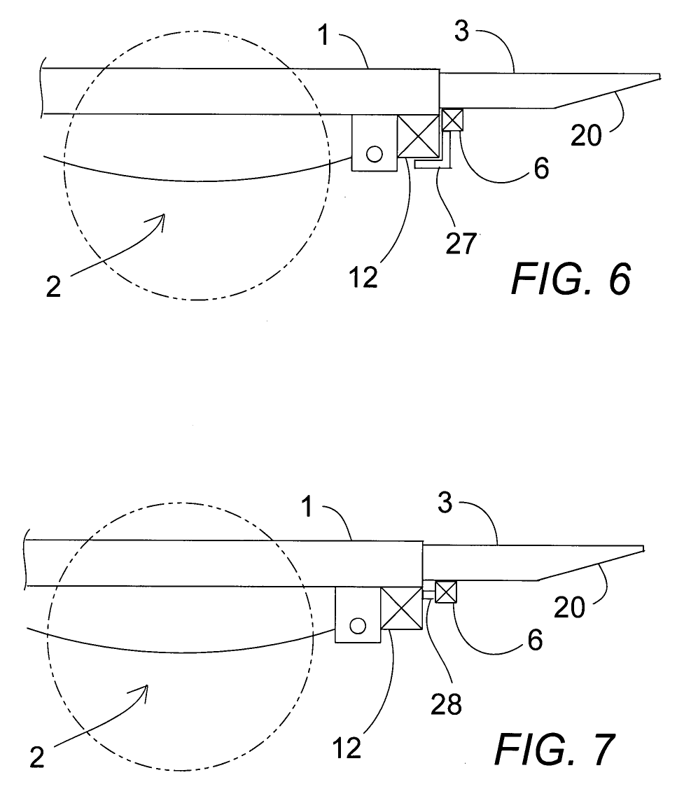

In FIG. 6, a metal ‘L’ shaped bracket 27 or brackets may be connected preferably by welding to the underside of the load bed 3 that engages the rear most part of the cradle 1, such as the cradle stop 12, when the bed is drawn ahead to its forward most position and acts as a security device to hold the bed and cradle together when the trailer is being moved or towed as a unit by the tow vehicle.

In FIG. 7, a locator pin 28 with a remote indicator may be connected to the underside of the load bed 3 that engages the rear most part of the cradle 1.

The present invention may further comprise a pull out rear extension to the loading bed may be added to facilitated loading and unloading on uneven ground when a slide ramp cam rise does not provide enough load bed fall to contact the ground.

The present invention may further comprise an emergency breakaway brake system at a back end of the load bed so that if the trailer separates from the tow vehicle while towing, the breakaway brake system acts as a deadmans's brake. This may be hydraulic or electronic.

The present invention may further comprise at least one limit switch to remotely indicate the position of the load bed in relation to the cradle and the status of a brake system on the cradle.

The present invention may further comprise an electrical lighting system located on the load bed and cradle of the trailer to provide side clearance markers and stopping indicators as well as directional indicators to allow the trailer to be operated safely in both day and night time conditions.

The trailer may be an open bed trailer or an enclosed trailer.

In order to reduce friction between the load bed and the cradle and to improve ease of sliding therebetween, the cradle's rear contact point 23 with the bed may incorporate a bearing or friction reducing contact pad.

An additional means for reducing friction between the load bed and the cradle at a front contact point and a back contact point of the cradle may be provided by a bearing or friction reducing cam follower.

The underside ends of the loading ramps 17 of the load bed 3 have tapered ends 20 for contacting the ground to allow the top of the bed to be level or to come in contact with the ground for ease of loading or unloading when the bed is in a rearmost position and to minimize any step between the bed and the ground.

The attaching point 9 on the bed is pivoting and could be at a level with the cradle 1 when the bed is in its forward most position. The towing arm 7, in its forward most position, such as when towing, is held in place by a manually installed locking pins 10 and 11 or electrically operated solenoid pin or spring loaded pin. When the bed 3 is in the forward most position, the towing arm 7 is contained in a channel or guides mounted on the bed to locate the arm and prevent lateral movement of the arm in relation to the bed and cradle.

In use, given the above three basic components, cradle 1, bed 3, and towing arm 7, a unique situation results when a fourth element is added and a force is applied. With the tow arm locking pin 11 removed and the cradle pin 10 removed and with the wheels of the cradle prevented from moving by use of the electric, hydraulic, or manual brake system, or blocks placed behind and in front of the wheels, when the tow vehicle is backed up, the bed 3 is pushed back along the cradle slide or channel 4 until the towing arm stop 5 comes in contact with the cradle rear motion stop contact point 15 or limiter. Similarly, if from this point the tow vehicle is moved forward, with the wheels locked and prevented from moving, the bed moves ahead until the bed front motion stop 6 comes in contact with the cradle front travel limiting stop contact point. 12.

At this point, a fourth element is added to the invention which provides a unique and significant improvement to what was formerly used in the art of trailer design.

A ‘wedge’ or slide ‘ramp’ (cam) 14 is attached (welded) to the bed's channel that runs in the ‘cradle’ slide area or raceway 4 and which acts as a vertical motion cam. This ‘wedge’/ramp (cam) 14 is tapered from a point just ahead of the front cradle channel location of the rear motion stop contact point 15 when the bed is in the forward most position in relation to the cradle, to a height called the ‘wedge’/ramp (cam) rise at its other end, the distance of which is established by the amount of travel (fall height) of the bed (to the ground) at the rear most point of the bed. The ‘wedge’/ramp (cam) height and length result in a rate of tilt of the bed (up at the front and down at the rear) and the distance of the tilt angle of the bed as a ratio to each other as the bed is forced backwards by the tow vehicle over and along the cradle slide area in the raceway 4. This would also provide a variable pivot point of the bed on a fixed or variable pivot point 23 on the cradle, as the bed moves back and forth.

With the bed 3 in the rear most position it provides a loading ramp 17 in itself for the load or vehicle to be carried. Further, inasmuch as the pivot point of the bed is not fixed and moves ahead as the bed is forced back over the cradle, the angle of the bed is not as great as a simple fixed (tilting) trailer bed, thereby facilitating easier loading of the load or vehicle to be carried on the trailer and less force or energy to push/pull the load/vehicle to be loaded up the bed to its loaded position on the bed as a result of the lesser angle or incline of the bed.

With the load/vehicle 60 loaded and secured on the bed, and the wheels of the cradle locked or prevented from moving, the tow vehicle is pulled/driven forward, drawing the bed ahead in relation to the cradle and lowering the front of the bed as the ‘wedge’/ramp (cam) rise height is reduced and until the bed front (forward motion) stop 6 comes in contact with the cradle stop 12 at which time the bed to cradle relationship is normal and the bed to cradle 10 and bed to tow arm 11 are locked to each other by use of a manually installed or electrically/spring operated solenoid.

Additional options and considerations are the use of a winch 18, shown in FIG. 1, electrically, hydraulically, or manually operated, and located on the bed 3 to assist the loading and unloading of a load or vehicle.

By virtue of the load carrying bed moving backward such as in the case of loading a vehicle, when the said vehicle is in the loaded position on the bed but before the bed is moved ahead on the cradle, the loaded position of the vehicle on the bed allows the doors of the loaded vehicle to be opened without interference with the wheels/tires or fender of the cradle.

The load bed 3 and/or cradle 1 may be made of steel, aluminum or a composite material to save weight and increase strength.

It is understood that the preceding description is given merely by way of illustration and not in limitation of the invention and that various modifications may be made thereto without departing from the spirit of the invention as claimed.

What is claimed is:

1. A tilt-bed trailer comprising:
a cradle comprising an elongated support structure mounted on a suspension system and axles and wheels, at least one pair of raceways mounted in a parallel spaced array along the length of the cradle, and means for maintaining the cradle in a stationary position relative to a ground surface below on which the wheels are resting;
a load bed slidably mounted to slide forward and backward in the at least one pair of raceways, the load bed comprising a pair of loading ramps along the length of the load bed extending beyond a back portion of the load bed, the pair of loading ramps aligned with the at least one pair of raceways on the cradle, at least one pair of front and back bed stops interacting with the cradle stops to limit forward and backward movement of the load bed, the load bed floating back and forth on the at least one pair of raceways on the cradle between the cradle stops, a means for locking the load bed to the cradle to prevent relative motion there between when transporting a load, and a central channel opening downwardly in a forward portion of the load bed;
a towing arm fit within the center channel of the load bed to locate the arm and prevent lateral movement of the arm in relation to the bed and cradle during towing, the towing arm comprising an elongated rigid arm having an attachment to a tow vehicle hitch at a proximal end of the towing arm and a pivoting attachment to a center portion of the load bed at a distal end of the towing arm, at a load bed center line, means for locking the towing arm onto the load bed with the towing arm in a forward position in the load bed central channel for towing;
at least two slide ramp cams attached to an underside of the load bed along a portion of the load bed adjacent to the sides of the load bed so that the at least two slide ramp cams ride in the channels of the cradle, each of the slide ramp cams comprising an elongated rigid wedge member tapering downwardly from a forward pointed end to a lower planar surface spaced apart from the bottom of the load bed so that with the cradle held stationary relative to the ground, the load bed unlocked from the cradle, and a towing vehicle backing up to push the towing arm and loading bed backward over the cradle, the at least two slide ramp cams act in unison sliding in the two raceways to act as vertical motion cams to elevate the loading ramp relative to the cradle and cause a back end of the load bed to extend rearward of the cradle and tilt downward from the pivoting attachment to the towing arm to contact the ground to move a load on the pair of loading ramps between the ground and the tilt-bed trailer, and when the load movement is complete, and the towing vehicle moves forward to pull the towing arm and the load bed forward, the at least two slide ramp cams slide forward over the cradle in the raceways to act as vertical motion cams to lower the load bed back onto the cradle.

2. The device of claim 1 wherein the cradle further comprises a front cradle stop at a front end of the cradle and a back cradle stop at a back end of the cradle and the towing arm further comprises a towing arm stop on an underside of the towing arm adjacent to the proximal end of the towing arm for the towing arm stop to interact with the front cradle stop to stop a backward movement of the towing arm and the load bed further comprises a load bed stop on an underside of the load bed adjacent to a distal end of the load bed for the load bed stop to interact with the back cradle stop to stop a forward movement of the load bed.

3. The device of claim 1 wherein the means for locking the load bed to the cradle comprises a manually installed pin.

4. The device of claim 1 wherein the means for locking the load bed to the cradle comprises an electrically controlled solenoid.

5. The device of claim 1 wherein the means for maintaining the cradle in a stationary position comprises a pair of blocks wedged under a front and back of one of the wheels.

6. The device of claim 1 wherein the means for maintaining the cradle in a stationary position comprises a set brake in the wheels.

7. The device of claim 1 further a winch attached to a topside of the load bed adjacent to the proximal end of the load bed to assist loading and unloading.

8. The device of claim 7 wherein the winch comprises at least one variety of winch taken from the list of varieties of winches including an electrically operated winch, a hydraulically operated winch and a manually operated winch.

9. The device of claim 1 further comprising a pull out rear extension to the loading bed to facilitated loading and unloading on uneven ground when a slide ramp cam rise does not provide enough load bed fall to contact the ground.

10. The device of claim 1 further comprising an emergency breakaway brake system at a back end of the load bed so that if the trailer separates from the tow vehicle while towing the breakaway brake system acts as a deadmans's brake.

11. The device of claim 1 further comprising at least one limit switch to remotely indicate the position of the load bed in relation to the cradle and the status of a brake system on the cradle.

12. The device of claim 1 further comprising an electrical lighting system located on the load bed and cradle of the trailer to provide side clearance markers and stopping indicators as well as directional indicators to allow the trailer to be operated safely in both day and night time conditions.

13. The device of claim 1 wherein the trailer comprises an open bed trailer.

14. The device of claim 1 wherein the trailer comprises an enclosed trailer.

15. The device of claim 1 further comprising means for reducing friction between the load bed and the cradle to improve ease of sliding therebetween.

16. The device of claim 1 a means for reducing friction between the load bed and the cradle at a front contact point and a back contact point of the cradle.

17. The device of claim 1 wherein the underside ends of the loading ramps of the load bed have tapered ends for contacting the ground to allow the top of the bed to be level or to come in contact with the ground for ease of loading or unloading when the bed is in a rearmost position and to minimize any step between the bed and the ground.
